(19) United States
(12) Patent Application Publication
(10) Pub. No.: US 2007/0196005 A1
(43) Pub. Date: Aug. 23, 2007

(54) Feature Tracing Process for M-mode Images

(76) Inventors: Christopher A. White, Toronto (CA); Stanley Shun Choi Poon, Thornhill (CA)

Correspondence Address: NEEDLE & ROSENBERG, P.C., SUITE 1000, 999 PEACHTREE STREET, ATLANTA, GA, 30309-3915, US

(21) Appl. No.: 11/677,941

(22) Filed: Feb. 22, 2007

Related U.S. Application Data
(60) Provisional application No. 60/775,921, filed on Feb. 23, 2006.

(51) Int. Cl. G06K 9/00

(52) U.S. Cl. 382/128

(57) ABSTRACT

A process for tracing an operator selected feature in an M-mode ultrasonic image comprises selecting a pixel of the selected feature within the M-mode image. A reference region is generated about the selected feature pixel and image intensity values are extracted for the reference region. A time point is selected in the M-mode ultrasonic image wherein the time point is at a different time than the selected feature pixel and a comparison region is generated about the selected time point. Image intensity values are extracted for the comparison region and a difference error is calculated for each location within the comparison region by comparing the reference region image intensity values with the comparison regions image intensity values. The location that has the smallest difference error is identified as a feature pixel at the time point.

### CROSS REFERENCES TO RELATED APPLICATIONS

This application claims priority to U.S. Provisional Patent Application with application No. 60/775,921 entitled “Feature Tracing Process for M-Mode Images,” which was filed on Feb. 23, 2006 and is hereby incorporated by reference in its entirety.

### BACKGROUND OF THE INVENTION

Ultrasound echography systems using a single beam in an ultrasound scan can be used to produce an M-mode image, where movement of a structure such as a heart wall can be depicted in a wave-like manner. M-mode imaging nominally produces a graph of depth and strength of reflection with time. Changes in movement (e.g., valve opening and closing or ventricular wall movement) can be displayed. With a high sampling frequency, M-mode ultrasound can be used to assess rates and motion and is used in cardiac imaging of both human and non-human animal subjects. The tracing, or outlining, of certain features in an M-mode image can be useful. Such features can include a beating heart wall where it can be useful for a researcher or clinician to be shown the edge of a heart wall.

### SUMMARY

In one exemplary aspect, an embodiment according to the present invention provides a method for tracing a user selected feature in an M-mode ultrasonic image. The method comprises as least receiving a selected feature of interest of said M-mode ultrasonic image; generating a reference region substantially about the feature of interest, wherein one or more reference region intensity values are determined for the reference region; receiving a selected time point in the M-mode ultrasonic image, wherein the time point is at a different time than said feature of interest; generating a comparison region substantially about the time point, wherein one or more comparison region intensity values are determined for the comparison region; determining a difference error by performing a comparison between the reference region intensity values and the comparison region intensity values; and determining a minimum value for said difference error, wherein a location is determined for the minimum difference error and the location of the minimum difference error is identified as a calculated location of the feature of interest at the time point. In one aspect the calculated location of the feature of interest is indicated on said M-mode ultrasonic image by, for example, imposing or overlaying a point of differing contrast or color on said M-mode ultrasonic image or displaying the calculated feature of interest location on the M-mode image as lines or curves connecting two or more calculated points.

In another exemplary aspect, an embodiment according to the present invention provides an apparatus for creating a tracing of a selected feature on an M-mode ultrasonic image. The apparatus is comprised of a processing unit having a data storage device for storing an M-mode ultrasound image; and a program module having executable code at least a portion of which is stored in the data storage device. The program module provides instructions to the processing unit. The program module is configured to cause the processing unit to select a pixel of the selected feature within the M-mode image, generate a reference region about the selected feature pixel, extract image intensity values for the reference region, select a time point in the M-mode ultrasonic image, wherein the time point is at a different time than the selected feature pixel, generate a comparison region about the selected time point, extract image intensity values for the comparison region, calculate a difference error for each location within the comparison region by comparing the reference region image intensity values with the comparison regions image intensity values, and identify the location that has the smallest difference error as a feature pixel at the time point. In one aspect, the difference error is calculated by said processing unit using a sum of absolute differences. In an optional aspect, the difference error is calculated by said processing unit by convolution.

In yet another exemplary aspect, an embodiment according to the invention provides an M-mode ultrasonic image with a traced selected feature produced by a process. The process comprises selecting a pixel of the selected feature within an M-mode ultrasonic image; generating a reference region about the selected feature pixel; extracting image intensity values for the reference region; selecting a time point in the M-mode ultrasonic image, wherein the time point is at a different time than the selected feature pixel; generating a comparison region substantially about the selected time point, wherein image intensity values are extracted for the comparison region; calculating a difference error for each location within the comparison region by comparing the reference region image intensity values with the comparison regions image intensity values; and identifying the location that has the smallest difference error as a feature pixel at the time point to provide the M-mode image with the traced feature.

In another exemplary aspect, an embodiment according to the present invention provides a computer program product for creating a tracing of a selected feature on an M-mode ultrasonic image, wherein the computer program product comprises at least one computer-readable storage medium having computer-readable program code portions stored therein. The computer-readable program code portions comprise a first executable portion for receiving a selected pixel of a selected feature within an M-mode image; a second executable portion for generating a reference region about the selected feature pixel and extracting image intensity values for the reference region; a third executable portion for selecting a time point in the M-mode ultrasonic image, wherein the time point is at a different time than the selected feature pixel, generating a comparison region about the selected time point, and extracting image intensity values for the comparison region; a fourth executable portion for calculating a difference error for each location within the comparison region by comparing the reference region image intensity values with the comparison regions image intensity values, and identifying the location that has the smallest difference error as a feature pixel at the time point.

Additional aspects and advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are not drawn to scale and wherein like reference characters used therein indicate like parts throughout the several drawings, are incorporated in and constitute a part of this specification, illustrate certain aspects of the instant invention and together with the description, serve to explain, without limitation, the principles of the invention:

FIG. 1 is an exemplary high resolution M-mode image of the left ventricle of a mouse wherein time is shown along the horizontal axis, and depth is shown along the vertical axis (2 sec×6 mm);

FIG. 2 is an exemplary Gaussian blurred (3×3) M-mode data set;

FIG. 3 shows an exemplary operator selected pixel on the bottom of a heart wall;

FIG. 4 shows an exemplary computer generated reference region around a selected pixel;

FIG. 5 shows exemplary extracted pixel intensities along the vertical line through the operator selected pixel for an exemplary reference region of size 1×32 pixels;

FIG. 6 shows exemplary extracted image intensities along a vertical line through the selected time point which is 10 pixels to the right of the original selected pixel's time point;

FIG. 7 shows an exemplary sum of absolute difference results, which are the difference errors;

FIG. 8 shows an exemplary tracing of the multiple calculated wall positions;

FIG. 9 is a flowchart of an exemplary process;

FIG. 10 is a flowchart of an exemplary process which comprises an optional filtering sub process;

FIG. 11 is a flowchart of an exemplary process that further comprises optionally updating the reference region;

FIG. 12 shows an exemplary computer system for implementation of embodiments of the invention;

FIG. 13 shows an exemplary ultrasound imaging system for acquiring ultrasound images and optionally for implementation of an embodiment of the invention; and

FIG. 14 shows the exemplary ultrasound imaging system of FIG. 13 and showing additional optional components for the acquisition of ECG and respiration data.

### DETAILED DESCRIPTION

The present invention may be understood more readily by reference to the following detailed description of the invention and the Examples included therein and to the Figures and their previous and following description.

Before the present compounds, compositions, articles, devices, and/or methods are disclosed and described, it is to be understood that this invention is not limited to specific synthetic methods, specific components, or to particular computer architecture, as such may, of course, vary. It is also to be understood that the terminology used herein is for the purpose of describing particular embodiments only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise. Thus, for example, reference to “a processing unit,” or to “a receive channel” includes two or more such processing units or receive channels, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point “15” are disclosed, it is understood that greater than, greater than or equal to, less than, less than or equal to, and equal to “10” and “15” are considered disclosed as well as between “10” and “15.” It is also understood that each unit between two particular units are also disclosed. For example, if “10” and “15” are disclosed, then “11,” “12,” “13,” and “14” are also disclosed.

“Optional” or “optionally” means that the subsequently described event or circumstance may or may not occur, and that the description includes instances where said event or circumstance occurs and instances where it does not.

By a “subject” is meant an individual. For example, the term subject includes small or laboratory animals, large animals, as well as primates, including humans. A laboratory animal includes, but is not limited to, a rodent such as a mouse or a rat. The term laboratory animal is also used interchangeably with animal, small animal, small laboratory animal, or subject, which includes mice, rats, cats, dogs, fish, rabbits, guinea pigs, rodents, etc. The term laboratory animal does not denote a particular age or sex. Thus, adult and newborn animals, as well as fetuses (including embryos), whether male or female, are included.

The described processes enable in vivo visualization, assessment, and measurement of anatomical structures and hemodynamic function in longitudinal imaging studies of small animals using ultrasound imaging. These processes can operate on ultrasound images having very high resolution, image uniformity, depth of field, adjustable transmit focal depths, and multiple transmit focal zones for multiple uses.

For example, an ultrasound image can be of a subject or an anatomical portion thereof, such as a heart or a heart valve. The image can also be of blood and can be used for applications including evaluation of the vascularization of tumors or guiding needle injections. Embodiments of this invention can be used with M-mode images generated by a single element transducer or a multiple element transducer array where the same region is imaged and movement of regions within the region are recorded. Embodiments of this invention are not limited to use with specific resolutions or sizes of images. Embodiments of this invention can be used with images acquired where contrast agents are used or not used. For example and not meant to be limiting, micro-bubble or nano-bubble contrast agents or combinations thereof can be used.

An M-mode ultrasound image displays intensity at certain depths along the y-axis and time along the x-axis. M-mode images can be useful for the study of moving things, including internal organs such as the heart. Due to differences in density an M-mode image can distinguish between varying regions of an organ and related tissue, such as a heart wall and blood.

A researcher or clinician or other operator can find it useful to have assistance in determining the location of certain features within the M-mode image. For example, the location of the heart wall can be of use to a small animal researcher. Tracing of a feature can be useful for rapid quantification of cardiac function. For example tracing both the endo-cardial wall and epi-cardial wall of the heart over time provides information on the relative health of the heart.

Examples of features which can be of interest include but are not limited to heart walls. Vessel walls can also be tracked. In one aspect, tracking both anterior and posterior vessel walls can give an area-time relationship which can allow cardiologists to asses the health and elasticity of vessels.

The location of the edge or boundary of a feature can be of interest to an operator. In one aspect, the edge can be considered a feature. Heart walls can comprise several layers or regions, such as the epi-cardial (outer wall of myocardium), the endo-cardial (inner wall of myocardium), and the septal wall, which separates the left and right ventricle. Heart walls may also be referred to as either the anterior or posterior wall. The study of these different features or layers of a heart wall can yield useful information such as measures of stress and strain, heart volume and area, vessel volume and area, and rates of change.

Often features are not easily visible to the naked eye in an M-mode image. Contrast between regions or boundaries of features may be low, making it difficult for an operator to approximate the edge of a feature. The outlining of the calculated edge of a feature by overlaying a tracing on an M-mode image can assist the operator in identifying the feature visually. Such a tracing can be a series of points imposed on the M-mode image, or can be a series of points connected by splines, wherein splines can be lines or curves connecting each point. The connection of points by splines is known to one of ordinary skill in the art.

An exemplary use of the disclosed methods and/or processes is the calculation of the approximate location of the edge of a heart wall, which can be traced on an M-mode image. This calculated position is an approximation of the actual position of the feature, namely the heart wall edge, as shown in the M-mode image.

In one aspect, the capturing of ultrasound data and subsequent production of an image, for example an M-mode image, comprises generating ultrasound, transmitting ultrasound into the subject, and receiving ultrasound reflected by the subject. A wide range of frequencies of ultrasound can be used to capture ultrasound data. For example, clinical frequency ultrasound (less than 20 MHz) or high frequency ultrasound (equal to or greater than 20 MHz) can be used. One skilled in the art can readily determine what frequency to use based on factors such as, for example but not limited to, depth of imaging and/or desired resolution.

High frequency ultrasound may be desired when high resolution imaging is desired and the structures to be imaged within the subject are not at too great a depth. Thus, capturing ultrasound data can comprise transmitting ultrasound having a frequency of at least 20 MHz into the subject and receiving a portion of the transmitted ultrasound that is reflected by the subject. For example, a transducer having a center frequency of about 20 MHz, 30 MHz, 40 MHz or higher can be used.

High frequency ultrasound transmission is often desirable for the imaging of small animals, where a high resolution may be achieved with an acceptable depth of penetration. The methods can therefore be used at clinical or high frequency on a small animal subject. Optionally, the small animal is selected from the group consisting of a mouse, rat, rabbit, and fish.

Moreover, it is contemplated that the methods and systems of the present invention are not limited to images acquired using any particular type of transducer. For example, any transducer capable of transmitting ultrasound at clinical or high frequency can be used. Many such transducers are known to those skilled in the art. For example, for high frequency transmission, transducers such as those used with the VisualSonics Inc. (Toronto, Canada), Vevo®660 or Vevo®770 high frequency ultrasound systems can be used. It is contemplated that high frequency and clinical frequency arrayed transducers can also be used.

Thus, the exemplified processes and methods of the present invention can be used with, and upon images produced by, an exemplary device such as the VisualSonics™ (Toronto, Canada) UBM system model VS40 VEVO™ 660. Another device is the VisualSonics™ (Toronto, Canada) model VEVO™ 770. Another such system can have the following components as described in U.S. patent application Ser. No. 10/683,890, US patent application publication 20040122319, which is incorporated herein by reference in its entirety.

Other devices capable of transmitting and receiving ultrasound at the desired frequencies can also be used. For example, ultrasound systems using arrayed transducers can be used. One such exemplary array system, which is incorporated herein by reference in its entirety for its teaching of a high frequency array ultrasound system, is described in U.S. Provisional Application No. 60/733,089, entitled “HIGH FREQUENCY ARRAY ULTRASOUND SYSTEM” by James Mehi, Ronald E. Daigle, Laurence C. Brasfield, Brian Starkoski, Jerrold Wen, Kai Wen Liu, Lauren S. Pflugrath, F. Stuart Foster, and Desmond Hirson, filed Nov. 2, 2005, and assigned attorney docket number 22126.0023U1 and U.S. patent application Ser. No. 11/592,741, entitled “High Frequency Arrayed Ultrasonic System” by Mehi et al., filed on Nov. 2, 2006, also incorporated herein by reference in its entirety.

The processes and methods can be used with platforms and apparatus used in imaging small animals including “rail guide” type platforms with maneuverable probe holder apparatuses. For example, the described processes can be used with multi-rail imaging systems, and with small animal mount assemblies as described in U.S. patent application Ser. No. 10/683,168, entitled “Integrated Multi-Rail Imaging System,” U.S. patent application Ser. No. 10/053,748, entitled “Integrated Multi-Rail Imaging System,” U.S. patent application Ser. No. 10/683,870, now U.S. Pat. No. 6,851,392, issued Feb. 8, 2005, entitled “Small Animal Mount Assembly,” and U.S. patent application Ser. No. 11/053,653, entitled “Small Animal Mount Assembly,” which are incorporated herein by reference in their entireties.

In alternative aspects, provided herein are processes and/or methods and apparatuses and/or systems for tracing an operator selected feature in an M-mode ultrasonic image. Such processes and apparatuses can be used in clinical diagnosis and small animal research. For example, the apparatuses and processes can be used for tracing anatomical features in a subject and for assessing the function or dysfunction of these anatomical features.

In one embodiment of the present invention, a process or method for tracing an operator selected feature in an M-mode ultrasonic image comprises selecting a pixel of the selected feature within the M-mode image. In one aspect, a reference region is generated about the selected feature pixel and image intensity values are extracted for the reference region. In another aspect, a time point is selected in the M-mode ultrasonic image wherein the time point is at a different time than the selected feature pixel and a comparison region is generated about the selected time point. In a further aspect, image intensity values are extracted for the comparison region and a difference error is calculated for each location within the comparison region by comparing the reference region image intensity values with the comparison regions image intensity values. In this aspect, the location that has the smallest difference error is identified as a feature pixel at the time point.

In one exemplary aspect, the process or method can comprise a difference error that is calculated by using a sum of absolute differences. In another aspect, the process or method can comprise a difference error that is calculated by convolution. In one aspect, the reference region can comprise a window. In one example, the reference window is about 3 pixels wide and 32 pixels deep. In another example, the selected time point can be about 5 pixels from the feature pixel. In a further aspect, the method or process can further comprise the operator selecting a region of interest for tracing a feature and repeating the method or process until the operator selected feature is traced across the region of interest.

The M-mode image can be of a subject. It is contemplated that the subject can be, without limitation, a human, an animal, a rodent, a rat, a mouse, and the like.

In one embodiment, an apparatus for creating a tracing of a selected feature on an M-mode ultrasound image comprises a processing unit having a data storage device for storing the M-mode ultrasound image. In this aspect, a program module is stored in the data storage device and provides instructions to the processing unit, which responds to the instructions of the program module. In one aspect, the program module can cause the processing unit to select a pixel of the selected feature within the M-mode image and to generate a reference region about the selected feature pixel. In another aspect, the program module can also cause the processing unit to extract image intensity values for the reference region and to select a time point in the M-mode ultrasonic image wherein the time point is at a different time than the selected feature pixel. In further exemplified aspects, the program module can further cause the processing unit to: a) generate a comparison region about the selected time point; b) extract image intensity values for the comparison region; c) calculate a difference error for each location within the comparison region by comparing the reference region image intensity values with the comparison regions image intensity values; and d) identify the location that has the smallest difference error as a feature pixel at the time point.

In one aspect, the program module of the apparatus can cause the processing unit to calculate a difference error wherein the difference error is calculated by using a sum of absolute differences. In another aspect, the difference error can be calculated by convolution. In a further aspect, the reference region created by the program module can comprise a window about, for example, 3 pixels wide and 32 pixels deep. In another aspect, the program module selected time point can be about 5 pixels from the feature pixel. The operator of the apparatus can selectively cause the program module to select a region of interest for tracing a feature and to repeat the method or process until the operator selected feature is traced across the region of interest.

Further provided is an exemplary M-mode ultrasound image with a traced selected feature created by a process described herein. For example, an M-mode image with a traced selected feature is created by selecting a pixel of the selected feature within the M-mode image and by generating a reference region about the selected feature pixel. Subsequently, image intensity values are extracted for the reference region and a time point is selected in the M-mode ultrasonic image wherein the time point is at a different time than the selected feature pixel. A comparison region is generated about the selected time point and image intensity values are extracted for the comparison region. Next, a difference error is calculated for each location within the comparison region by comparing the reference region image intensity values with the comparison regions image intensity values. The location that has the smallest difference error is identified as a feature pixel at the time point to provide the M-mode image with the traced feature.

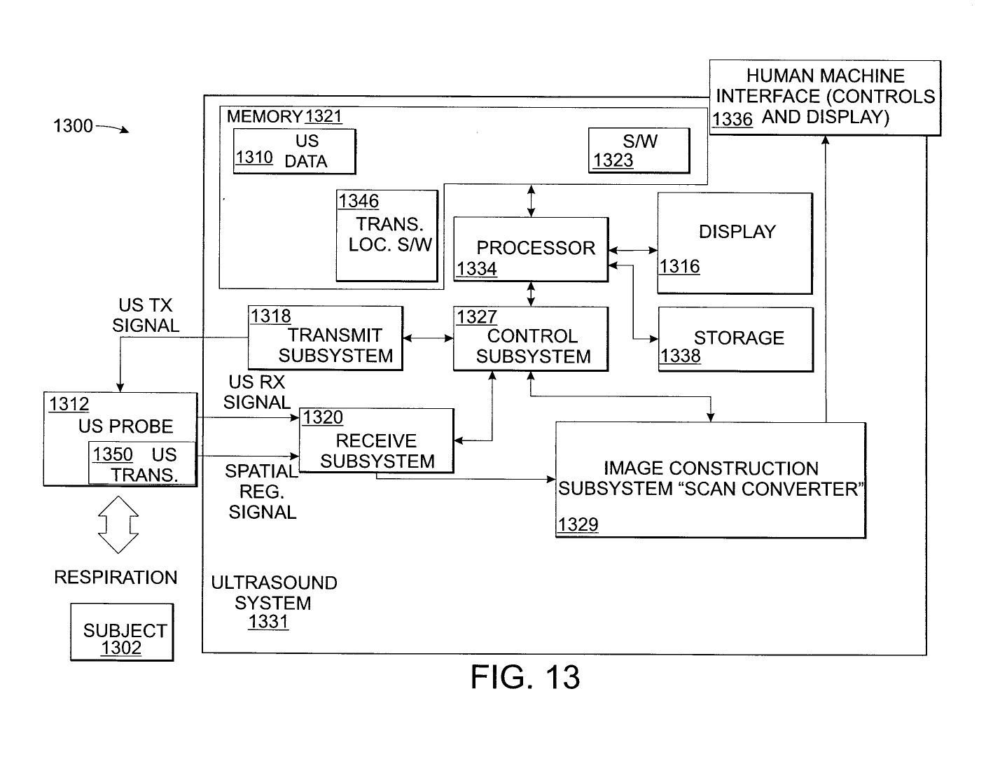

It is contemplated that the described processes or methods can be performed using an ultrasound system capable of capturing ultrasound M-mode data or images. One exemplary ultrasound system that can be used is shown in FIG. 13. The exemplary system described in FIG. 13 is a high frequency single element transducer ultrasound system. Other exemplary systems that could also be used include high frequency and clinical frequency single element transducer and arrayed transducer systems.

FIG. 13 is a block diagram illustrating an exemplary imaging system 1300. This imaging system 1300 can be used to acquire M-mode images for use in the described processes. Optionally, this imaging system 1300 can be used to perform the embodiments of the invention described herein.

The imaging system 1300 operates on a subject 1302. An ultrasound probe 1312 is placed in proximity to the subject 1302 to obtain ultrasound image information. As noted above, the ultrasound probe can comprise a single element mechanically moved transducer 1350 or a multi-element array transducer that can be used for collection of ultrasound data 1310, including ultrasound M-mode data. The system and method can be used to generate M-mode images. In one example, the transducer can transmit ultrasound at a frequency of at least about 20 megahertz (MHz). For example, the transducer can transmit ultrasound at or above about 20 MHz, 30 MHz, 40 MHz, 50 MHz, or 60 MHz. Further, the use of transducer operating frequencies that are significantly greater than those mentioned is also contemplated.

In this exemplary aspect, the ultrasound system 1331 includes a control subsystem 1327, an image construction subsystem 1329, sometimes referred to as a scan converter, a transmit subsystem 1318, a receive subsystem 1320, and an operator input device in the form of a human machine interface 1336. The processor 1334 is coupled to the control subsystem 1327 and the display 1316 is coupled to the processor 1334. The processor 1334 is coupled to the control subsystem 1327 and the display 1316 is coupled to the processor 1334. A memory 1321 is coupled to the processor 1334. The memory 1321 can be any type of computer memory, and is typically referred to as random access memory “RAM,” in which the software 1323 of the invention executes. Software 1323 controls the acquisition, processing and display of the ultrasound data allowing the ultrasound system 1300 to display an image.

The processor 1334 can be used to perform embodiments of the method as described in the general context of computer instructions, such as program modules, being executed by a computer. Generally, program modules include routines, programs, objects, components, data structures, etc. that performs particular tasks or implement particular abstract data types. The memory 1321 can serve as a data storage device for storage of M-mode images. Such images can also be stored on other data storage devices as described elsewhere herein, including computer readable memory.

The processor 1334 and related components such as memory 1321 and computer readable medium 1338 can be considered a processing unit.

The methods and systems can be implemented using a combination of hardware and software. The hardware implementation of the system can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the system comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” or “computer-readable storage medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-limiting and non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Memory 1321 also includes the ultrasound data 1310 obtained by the ultrasound system 1331. A computer readable storage medium 1338 is coupled to the processor for providing instructions to the processor to instruct and/or configure the processor to perform algorithms related to the operation of ultrasound system 1331, as further explained below. The computer readable medium can include hardware and/or software such as, by the way of example only, magnetic disk, magnetic tape, optically readable medium such as CD ROMs, and semiconductor memory such as PCMCIA cards. In each case, the medium may take the form of a portable item such as a small disk, floppy disk, cassette, or may take the form of a relatively large or immobile item such as a hard disk drive, solid state memory card, or RAM provided in the support system. It should be noted that the above listed example mediums can be used either alone or in combination.

The exemplary ultrasound system 1331 can comprise a control subsystem 1327 to direct operation of various components of the ultrasound system 1331. The control subsystem 1327 and related components may be provided as software for instructing a general purpose processor or as specialized electronics in a hardware implementation. In one aspect, the ultrasound system 1331 comprises an image construction subsystem 1329 for converting the electrical signals generated by the received ultrasound echoes to data that can be manipulated by the processor 1334 and that can be rendered into an image on the display 1316. In one aspect, the control subsystem 1327 is connected to a transmit subsystem 1318 to provide ultrasound transmit signal to the ultrasound probe 1312. The ultrasound probe 1312 in turn provides an ultrasound receive signal to a receive subsystem 1320, which provides signals representative of the received signals to the image construction subsystem 1329. In one aspect, the receive subsystem 1320 is also connected to the control subsystem 1327. In another aspect, the scan converter 1329 for the image construction subsystem is directed by the control subsystem 1327 to operate on the received data to render an image for display using the image data 1310.

As noted above, the receive subsystem 1320 is connected to the control subsystem 1327 and an image construction subsystem 1329. The image construction subsystem 1329 is directed by the control subsystem 1327. In operation, the imaging system 1300 transmits and receives ultrasound data with the ultrasound probe 1312, provides an interface to an operator to control the operational parameters of the imaging system 1300, and processes data appropriate to formulate still and moving images that represent anatomy and/or physiology of the subject 1302. Images are presented to the operator through the display 1316.

The human machine interface 1336 of the ultrasound system 1300 takes input from the operator and translates such input to control the operation of the ultrasound probe 1312. The human machine interface 1336 also presents processed images and data to the operator through the display 1316. Using the human machine interface 1336, an operator can define the area in which image data 1310 is collected from the subject 1302. In one aspect, software 1323 in cooperation with the image construction subsystem 1329 operate on the electrical signals developed by the receive subsystem 1320 to develop an ultrasound image.

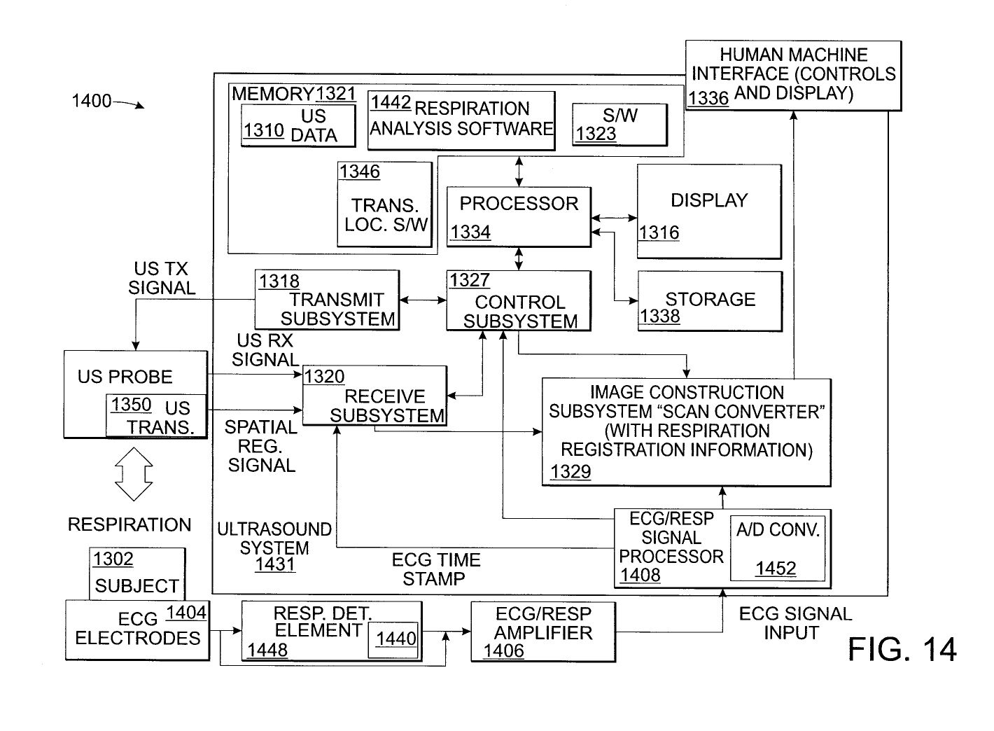

Optionally, an exemplary ultrasound imaging system shown in FIG. 14 can be used to acquire M-mode images as well as respiratory and ECG information from the subject. In addition, the exemplary system of FIG. 14 can be used to perform the embodiments of the present invention. FIG. 14 shows the components of the exemplary ultrasound imaging system 1300 of FIG. 13, using the same identification numbers, as well as the optional components which can be used to acquire and process the respiratory and ECG information.

In one aspect, the subject 1302 can be connected to electrocardiogram (ECG) electrodes 1404 to obtain a cardiac rhythm and respiration waveform from the subject 1302. In a further aspect, a respiration detection element 1448, which comprises respiration detection software 1440, can be used to produce a respiration waveform for provision to an ultrasound system 1431. In this aspect, respiration detection software 1440 can produce a respiration waveform by monitoring muscular resistance when a subject breathes. The use of ECG electrodes 1404 and respiration detection software 1440 to produce a respiration waveform can be performed using a respiration detection element 1448 and software 1440 known in the art and available from, for example, Indus Instruments, Houston, Tex.

In one aspect, the respiration detection software 1440 converts electrical information from the ECG electrodes 1404 into an analog signal that can be transmitted to the ultrasound system 1431. The analog signal is further converted into digital data by an analog-to-digital converter 1452, which can be included in a signal processor 1408 or can be located elsewhere, after being amplified by an ECG/respiration waveform amplifier 1406. In one embodiment, the respiration detection element 1448 comprises an amplifier for amplifying the analog signal for provision to the ultrasound system 1400 and for conversion to digital data by the analog-to-digital converter 1452. In this embodiment, use of the amplifier 1406 can be avoided entirely. Using digitized data, respiration analysis software 1442 located in memory 1321 can determine characteristics of a subject's breathing including respiration rate and the time during which the subject's movement due to respiration has substantially stopped.

In one aspect, cardiac signals from the electrodes 1404 and the respiration waveform signals can be transmitted to an ECG/respiration waveform amplifier 1406 to condition the signals for provision to an ultrasound system 1431. It is contemplated that a signal processor or other such device may be used instead of an ECG/respiration waveform amplifier 1406 to condition the signals. One skilled in the art will appreciate that, if the cardiac signal or respiration waveform signal from the electrodes 1404 is suitable, then use of the amplifier 1406 can be avoided entirely.

Optionally, respiration analysis software 1442 can control when ultrasound image data 1310 is collected based on input from the subject 1302 through the ECG electrodes 1404 and the respiration detection software 1440. In this aspect, the respiration analysis software 1442 can control the collection of ultrasound data 1310 at appropriate time points during the respiration waveform. Thus, in the exemplary system described, the software 1323, the respiration analysis software 1442 and the transducer localizing software 1346 can control the acquisition, processing and display of ultrasound data, and can allow the ultrasound system 1331 to capture ultrasound images at appropriate times during the respiration waveform of the subject.

In one aspect, the ultrasound system 1400 may include the ECG/respiration waveform signal processor 1408. The ECG/respiration waveform signal processor 1408 is configured to receive signals from the ECG/respiration waveform amplifier 1406 if the amplifier is utilized. If the amplifier 1406 is not used, the ECG/respiration waveform signal processor 1408 can also be adapted to receive signals directly from the ECG electrodes 1404 or from the respiration detection element 1448. The signal processor 1408 can convert the analog signal from the respiration detection element 1448 and software 1440 into digital data for use in the ultrasound system 1431. Thus, the ECG/respiration waveform signal processor can process signals that represent the cardiac cycle as well as the respiration waveform. In another aspect, the ECG/respiration waveform signal processor 1408 provides various signals to the control subsystem 1327. In a further aspect, the receive subsystem 1320 also receives ECG time stamps or respiration waveform time stamps from the ECG/respiration waveform signal processor 1408.

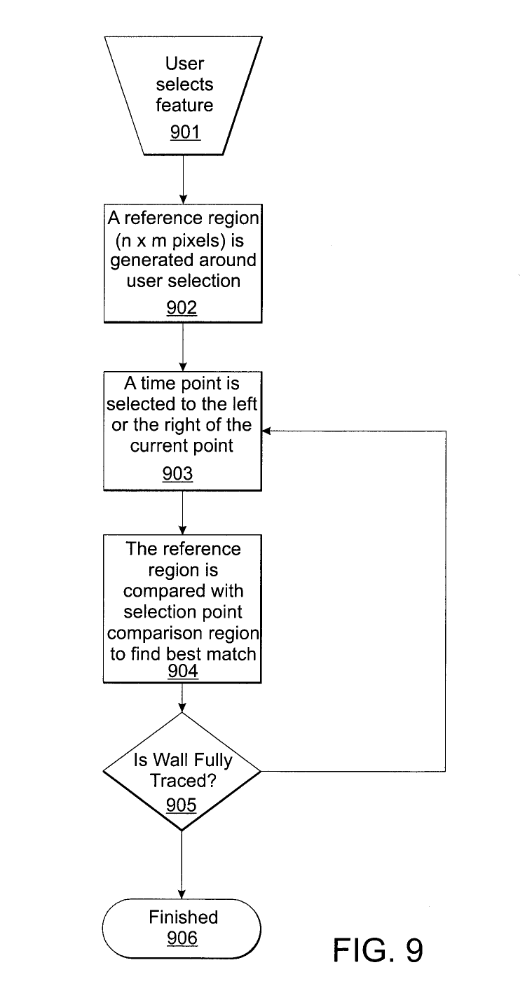

FIG. 9 is a block diagram illustrating an exemplary process for tracing an operator selected feature in an M-mode ultrasonic image. The exemplary process can be performed upon images produced by, or using the exemplary system shown in FIG. 13 or FIG. 14 and as described above. One skilled in the art will appreciate that the exemplary process can also be used with other exemplary ultrasound imaging systems capable of capturing M-mode data and/or with other operating environments capable of processing M-mode ultrasound data.

In block 901, an operator selects a feature of interest. The operator can select one pixel at a point on the feature of interest. Optionally, the operator can also select an additional point indicating the width of the region of interest—that is the end point over which a feature trace will be calculated. If no operator end point is selected, a predefined end point can be used. The width of the region of interest can range from 2 pixels to the full width of the M-mode image.

Exemplary features which can be selected by the operator can be any feature of interest such as a heart wall edge, an inner heart wall, or other features described herein or known to one of ordinary skill in the art.

A reference region is selected in block 902. This reference region can be an n×m window where the units can be distance units or can be pixels. “m” represents the vertical axis which is depth. “n” represents the horizontal axis which is time. The size can depend on the resolution of the image. Exemplary reference regions for a 256 pixel resolution image can be 3×32 pixels, or 1×32 pixels or 2×32 pixels. The size of the reference region can be based on the size of the wall features and the acquisition resolution of the device. For example, a region in a mouse that encompasses both a small region of blood and a small region of heart wall is about 0.5 mm deep. If the acquisition resolution is about 64 pixels per mm then the reference region would be about 32 pixels high.

In other animal models, including humans, the reference region in mm can be larger, for example, about 5 mm in a human. If the acquisition resolution is 16 pixels per mm, the window region can be 80 pixels.

In one example, in the time direction, the number of pixels are set to correspond to approximately 0.25 to 2 ms of data. This corresponds to about 1 pixel if the acquisition rate is 4000 lines per second. The reference region can be represented in distance and time units respectively, with one of ordinary skill in the art understanding the conversions between pixels and distance or time.

In block 903 a time point is selected at location on the time axis other than the operator selected pixel time location. This time point can be to the left or to the right (before or after in time) of the operator selected pixel location. For example, the distance can be about 1 to about 10 ms away from the selected pixel. This time point does not have to be selected by the operator, and can be predetermined by the processing unit.

In one aspect, the rate of movement of the feature of interest can determine the interval or step size. For instance, the heart rate of a mouse can be about 100 ms for one heart cycle. The distance can be chosen to acquire adequate intervals to capture motion features of interest. For example, for a 100 ms heart cycle, a step size of 10 ms can be used. In a human with a slower heart rate than a mouse, a larger step size can be used; for example 30 ms in humans. The sample interval can equate to about 10 samples during a heart cycle and can be used to calculate the distance of each step. In one example, the interval can be about 5 or more samples per heart cycle.

If very short steps (or more samples per heart cycle) are chosen, averaging of the trace points calculated by embodiments of the process can be done to provide a smoother trace. Averaging can be done using methods known to one of ordinary skill in the art.

The time point selection can extend to the left, the right, or in both directions. The direction can be chosen so that the resulting trace is generated for an operator selected area of interest. The operator selected area of interest can be a region selected by the operator over which a trace is required. The selected area of interest can also be predetermined by the processing unit, for example, it can encompass a region consisting of a predefined time in the forward or reverse direction from the initial user selected point.

At block 904, a comparison is done between the image intensities of the reference region and the image intensities of the comparison region surrounding the selected time point (variable k). The reference region is an n×m region. The comparison region is a line or surface or volume of dimension m comprising m×the entire depth of the image (resolution of the image). For example, if a 1×32 reference region is used, with an image of 256 pixel resolution, the comparison region is 1×256, which can be visually understood as a line (or curve) plotted in 2 dimension space.

The smaller reference region can be moved along the comparison region with a difference error being calculated for each point of comparison. For reference regions of m>1, the regions can be thought of as surfaces or volumes of multi-dimension character. This step can be thought of as obtaining the “best fit location” for a small plane in a larger plane, where the planes can be multi-dimensional.

The comparison or fitting step yields a difference error at each point of comparison along the m-dimensional surface of the comparison region. For a time point k, the difference error can be calculated by using the absolute sum of differences shown mathematically as:

$${Error}_{k} = {\sum }_{i = 0}^{n} {\sum }_{j = 0}^{m} abs ( {Ref}_{i , j} - {Data}_{i , j + k} )$$

where k is the currently selected time point and where kₘᵢₙ=min(Errorₖ).kₘᵢₙ=min(Errorₖ). In an alternative embodiment, the difference error can be calculated by using the sum of the square of differences shown mathematically as:

$${Error}_{k} = {\sum }_{i = 0}^{n} {\sum }_{j = 0}^{m} {( {Ref}_{i , j} - {Data}_{i , j + k} )}^{2}$$

Optionally, the difference error can be calculated using a convolution equation. Optional embodiments compute a difference error across a depth region of less than the entire depth region. This limited depth region can be chosen by selecting a depth region that is close to the previous depth region. For example, instead of searching over all 256 vertical depth pixels a search over a window of 64 pixels surrounding the previously calculated depth point could be performed.

The location of the minimum difference error is identified as the calculated location of the feature at the chosen time point. This location is indicated on the tracing. Typically, the tracing can be shown by imposing or overlaying a point of differing contrast or color.

In block 905, the process checks to see if the feature tracing has reached the end of the region of interest. If not, the process loops back to block 903 and repeats. If the end of the region of interest has been reached, the process is complete. Note that the indication of the calculated feature location (the tracing) can take place in block 904 or can take place once the end of the region of interest is reached.

The calculated feature locations can be displayed on the M-mode image as points or can be displayed as lines or curves connecting two or more calculated points. The use of splines to connect these points is discussed herein.

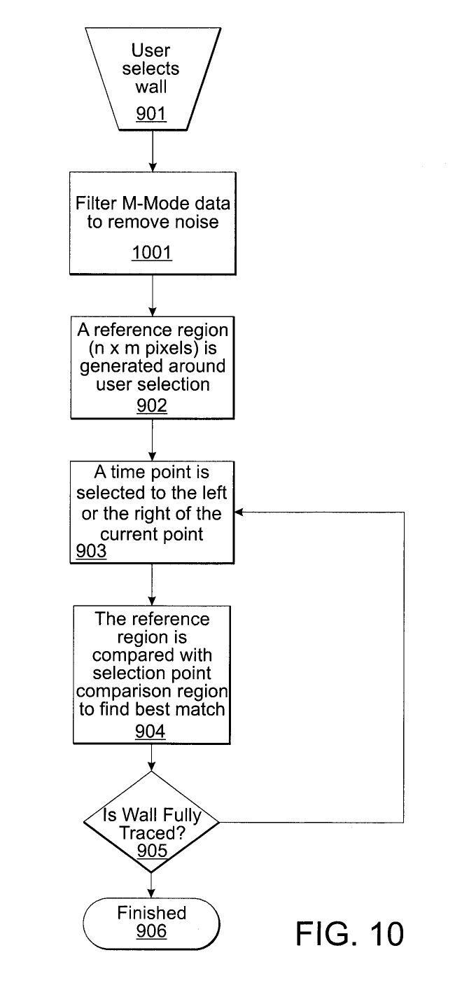

FIG. 10 shows an optional step to the exemplary embodiment shown in FIG. 9. At block 1001 a filter is applied to remove noise from the M-mode image. Such noise can be of a random nature. Types of filters can be noise reduction filters known to one of skill in the art. For example a Gaussian filter can be used. A Gaussian filter of 3×3 pixel size can be used. The size and type of filter can be selected based on the image resolution of the M-mode image. For example, for a higher resolution image, a 5×5 Gaussian filter may be appropriate. Other types of filters can be box filters, low pass filters, or spectral filters. Filters can be implemented in the frequency domain or the image domain. Filtering can enhance the ability of process to calculate the location of a feature.

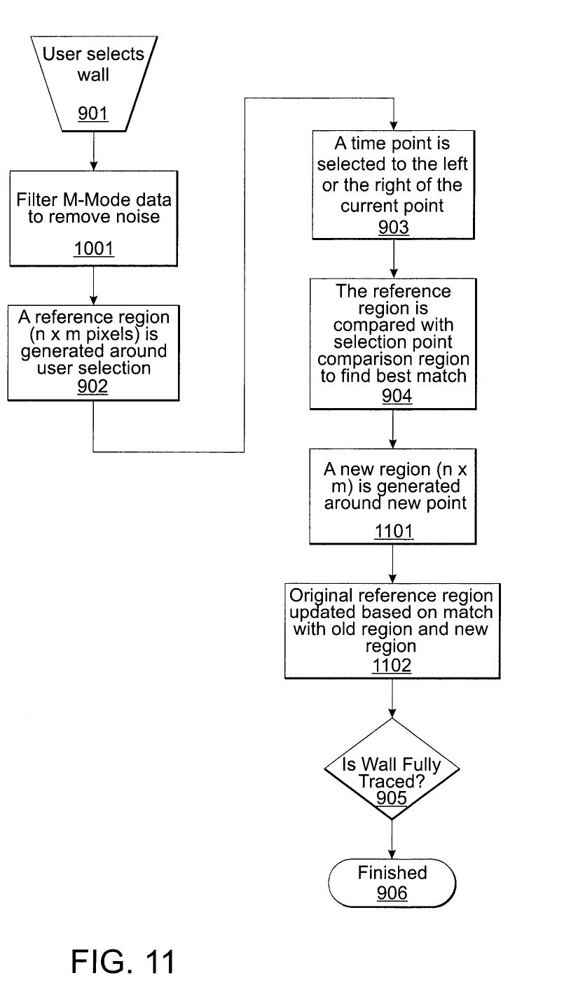

FIG. 11 shows the process of FIG. 10 with additional optional steps in blocks 1101 and blocks 1102. Block 1101 creates a reference region of n×m about the location of the selected time point. Block 1102 uses the original reference region and combines it with the reference region about the selected time point to create a new reference region. This combination can be done using a weighted average. For example, a ¾ weight to original reference region and ¼ weight to the reference region about the selected time point can be used. Of course, it is contemplated that other weighting values can be used as well. The filtering step of block 1001 is optional for the process shown in FIG. 10.

Additional embodiments of the processes described herein can further comprise the use of a respiration signal and an ECG signal taken from the subject 1302. The respiration signal can provide a waveform indicative of the subject's breathing cycle while the ECG signal can provide a waveform indicative of the subject's heart cycle. The respiration signal can be acquired by measuring the electrical resistance of the animal over time (for example via an Indus Instruments, Houston, TX Indus system) or by measuring chest volume which records the chest displacement over time. Both respiration and ECG signals can be used to improve the fit of the tracing feature.

In one aspect, the ECG signal can be used to estimate at what point in the heart cycle a particular M-mode line (time point) occurs. In subjects, heart cycles can be representatively similar. A successfully traced heart cycle can be indicative of a pattern that subsequent heart cycles can follow. Thus embodiments of the process can use the previous heart cycle trace as a starting point for heart wall tracing.

In another aspect, the respiration signal can be used to exclude from the trace process data that may not represent heart wall motion. When the subject is breathing, the M-mode data can be corrupted due to the additional non-cardiac motion, which can make wall detection more difficult. Using the respiration signal, data representing the region over the respiration event can be excluded from the trace process.

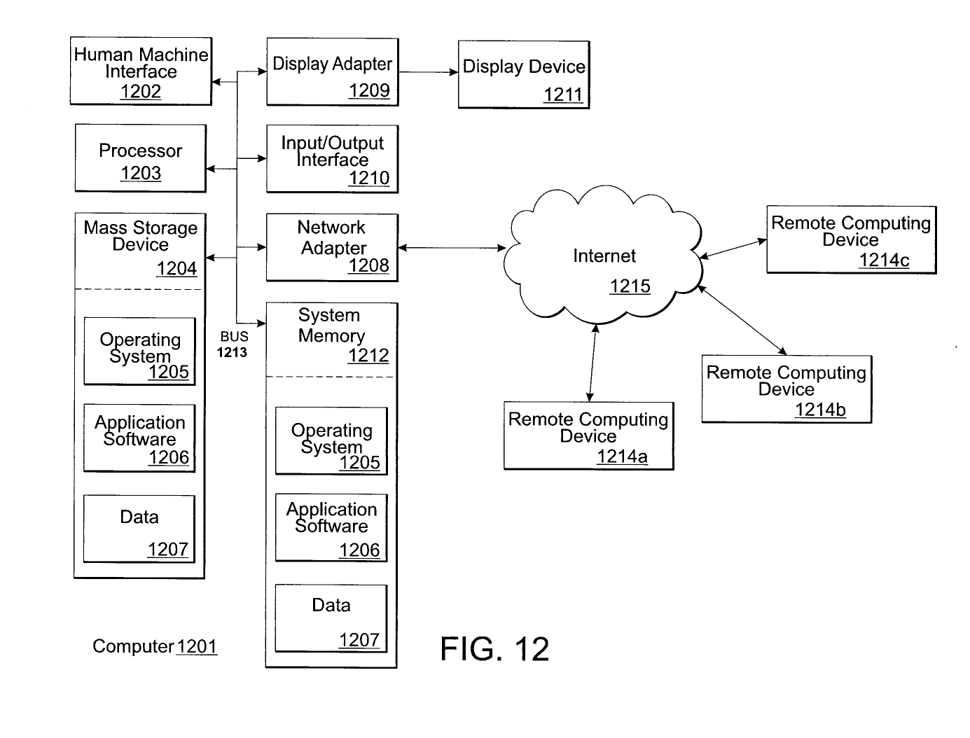

FIG. 12 is a block diagram illustrating an additional exemplary operating environment for performing the disclosed processes. M-mode data captured using an ultrasound system can be provided to the exemplary operating environment for performing the described processes. For example, M-mode data captured using the exemplary system illustrated in FIG. 13, or FIG. 14, or another exemplary ultrasound system capable of capturing M-mode data can be used.

This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The described processes can be operational with numerous other general purpose or special purpose computing system environments or configurations. Examples of well known computing systems, environments, and/or configurations that may be suitable for use with the system and method include, but are not limited to, personal computers, server computers, laptop devices, microcontrollers, and multiprocessor systems. Additional examples include set top boxes, programmable consumer electronics, network PCs, minicomputers, mainframe computers, distributed computing environments that include any of the above systems or devices, and the like.

Embodiments of the processes may be described in the general context of computer instructions, such as program modules, being executed by a computer. Generally, program modules include routines, programs, objects, components, data structures, etc. that perform particular tasks or implement particular abstract data types. The system and method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 1201. The components of the computer 1201 can include, but are not limited to, one or more processors or processing units 1203, a system memory 1212, and a system bus 1213 that couples various system components including the processor 1203 to the system memory 1212.

The system bus 1213 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 1213, and all buses specified in this description can also be implemented over a wired or wireless network connection and each of the subsystems, including the processor 1203, a mass storage device 1204, an operating system 1205, application software 1206, data 1207, a network adapter 1208, system memory 1212, an Input/Output Interface 1210, a display adapter 1209, a display device 1211, and a human machine interface 1202, can be contained within one or more remote computing devices 1215a,b,c at physically separate locations, connected through buses of this form, in effect implementing a fully distributed system.

The computer 1201 typically includes a variety of computer readable media. Such media can be any available media that is accessible by the computer 1201 and includes both volatile and non-volatile media, removable and non-removable media. The system memory 1212 includes computer readable media in the form of volatile memory, such as random access memory (RAM), and/or non-volatile memory, such as read only memory (ROM). The system memory 1212 typically contains data such as data 1207 and/or program modules such as operating system 1205 and application software 1206 that are immediately accessible to and/or are presently operated on by the processing unit 1203.

The computer 1201 may also include other removable/non-removable, volatile/non-volatile computer storage media. By way of example, FIG. 12 illustrates a mass storage device 1204 which can provide non-volatile storage of computer code, computer readable instructions, data structures, program modules, and other data for the computer 1201. For example, a mass storage device 1204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. When “data storage device” is used herein it can mean system memory and/or mass storage devices.

Any number of program modules can be stored on the mass storage device 1204, including by way of example, an operating system 1205 and application software 1206. Each of the operating system 1205 and application software 1206 (or some combination thereof) may include elements of the programming and the application software 1206. Data 1207 can also be stored on the mass storage device 1204. Data 1204 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

An operator can enter commands and information into the computer 1201 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 1203 via a human machine interface 1202 that is coupled to the system bus 1213, but may be connected by other interface and bus structures, such as a parallel port, game port, or a universal serial bus (USB).

A display device 1211 can also be connected to the system bus 1213 via an interface, such as a display adapter 1209. For example, a display device can be a monitor or an LCD (Liquid Crystal Display). In addition to the display device 1211, other output peripheral devices can include components such as speakers (not shown) and a printer (not shown) which can be connected to the computer 1201 via Input/Output Interface 1210.

The computer 1201 can operate in a networked environment using logical connections to one or more remote computing devices 1214a,b,c. By way of example, a remote computing device can be a personal computer, portable computer, a server, a router, a network computer, a peer device or other common network node, and so on. Logical connections between the computer 1201 and a remote computing device 1214a,b,c can be made via a local area network (LAN) and a general wide area network (WAN). Such network connections can be through a network adapter 1208. A network adapter 1208 can be implemented in both wired and wireless environments. Such networking environments are commonplace in offices, enterprise-wide computer networks, intranets, and the Internet 1215.

For purposes of illustration, application programs and other executable program components such as the operating system 1205 are illustrated herein as discrete blocks, although it is recognized that such programs and components reside at various times in different storage components of the computing device 1201, and are executed by the data processor(s) of the computer. An implementation of application software 1206 may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. An implementation of the disclosed method may be stored on or transmitted across some form of computer readable media.

The processing of the disclosed processes can be performed by software components. The disclosed processes may be described in the general context of computer-executable instructions, such as program modules, being executed by one or more computers or other devices. Generally, program modules include computer code, routines, programs, objects, components, data structures, etc. that perform particular tasks or implement particular abstract data types. The disclosed processes may also be practiced in grid-based and distributed computing environments where tasks are performed by remote processing devices that are linked through a communications network. In a distributed computing environment, program modules may be located in both local and remote computer storage media including memory storage devices.

### EXAMPLE

The following examples are put forth so as to provide those of ordinary skill in the art with a complete disclosure and description of how the processes, methods, apparatuses and/or systems claimed and described herein are made and evaluated, and are intended to be purely exemplary of the invention and are not intended to limit the scope of what the inventors regard as their invention. Efforts have been made to ensure accuracy with respect to numbers (e.g., time, distance, etc.), but some errors and deviations should be accounted for.

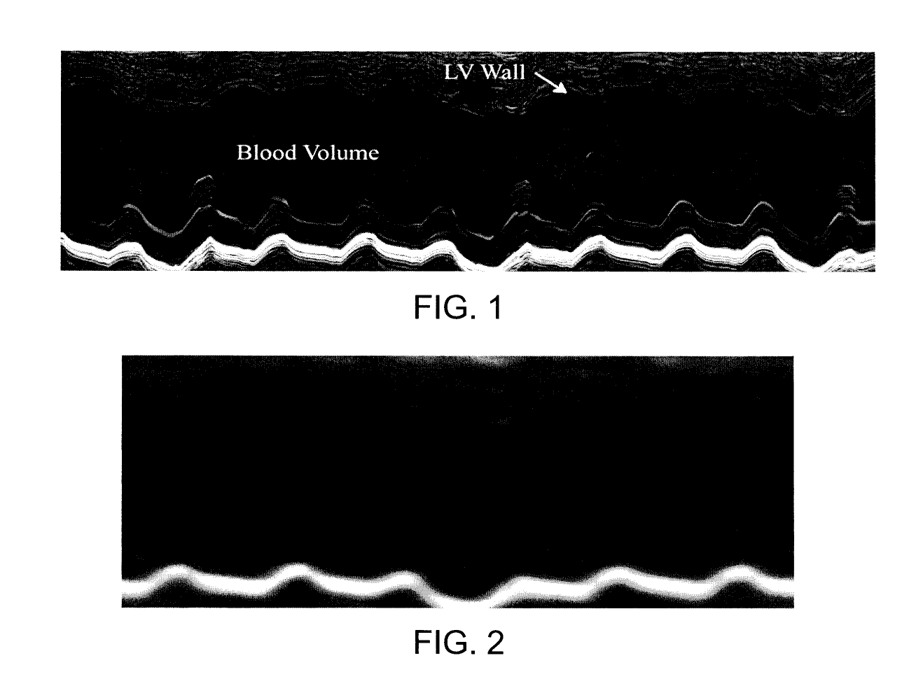

Exemplary methods described herein are based on similar feature analysis which can be useful with images of low, medium, or high contrast. In an exemplary embodiment of the invention, an M-mode data image set, an example of which is visually depicted in FIG. 1, is identified for analysis. FIG. 1 shows a high resolution M-mode image of the left ventricle of a mouse. Time is along the horizontal axis and depth is along the vertical axis. The intensity of each pixel of the image is displayed using a grayscale.

The image can optionally be filtered to reduce noise. Filtering can be performed using a 3×3 Gaussian blur filter for example. FIG. 2 shows an M-mode data image set after application of a 3×3 Gaussian filter. Filtering is not restricted to Gaussian filters. Other noise reduction techniques, as known to one of ordinary skill in the art, can be used such as, but not limited to, box filters, low pass filters, or spectral filters.

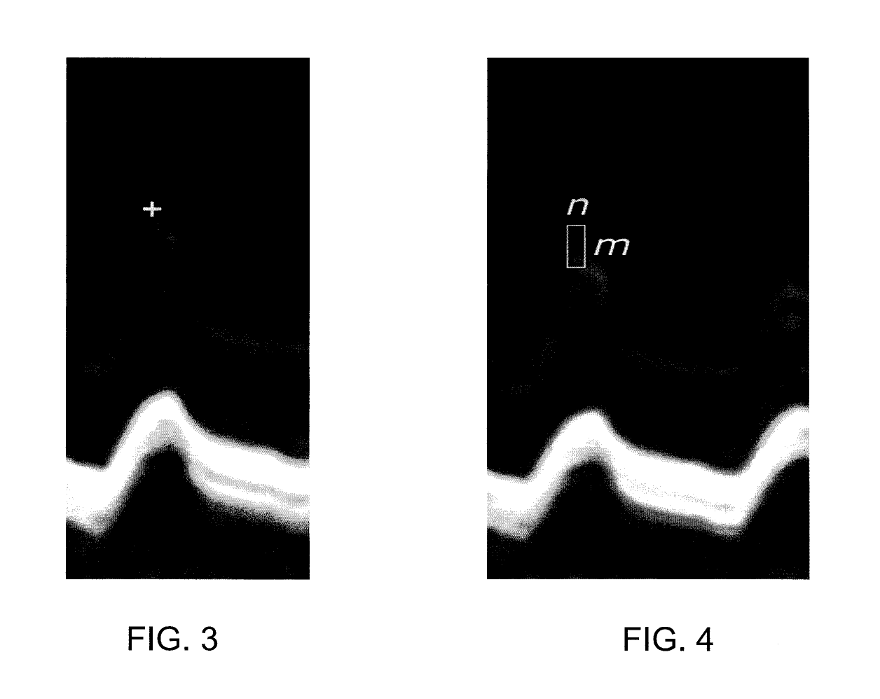

The operator, who can be a researcher that desires to have assistance in identifying a feature in the image, in this example the left ventricle wall, can initiate the tracing of the wall by selecting the feature of interest on the acquired M-mode image. FIG. 3 shows a cross placed on the operator selected pixel on the bottom of the heart wall. In this example, the operator has selected both a position and time in the image. That position represents the feature the operator desires to have traced—namely in this example the edge of the heart wall. This operator selected feature, in this example, corresponds to a pixel of the image. This pixel defines the original time point and can be used for future feature (wall) detection.

A comparison region, comprising m pixels (vertical axis or depth axis) above and below the selection point, and n pixels (horizontal axis or time axis) right and left of the selection point, defines a reference region. An example of this reference region is shown in FIG. 4. Typically the reference region size is approximately 3×32 pixels; other sizes, such as 1×32 or 2×32 can also be used. The reference region of FIG. 4 is 1×32.

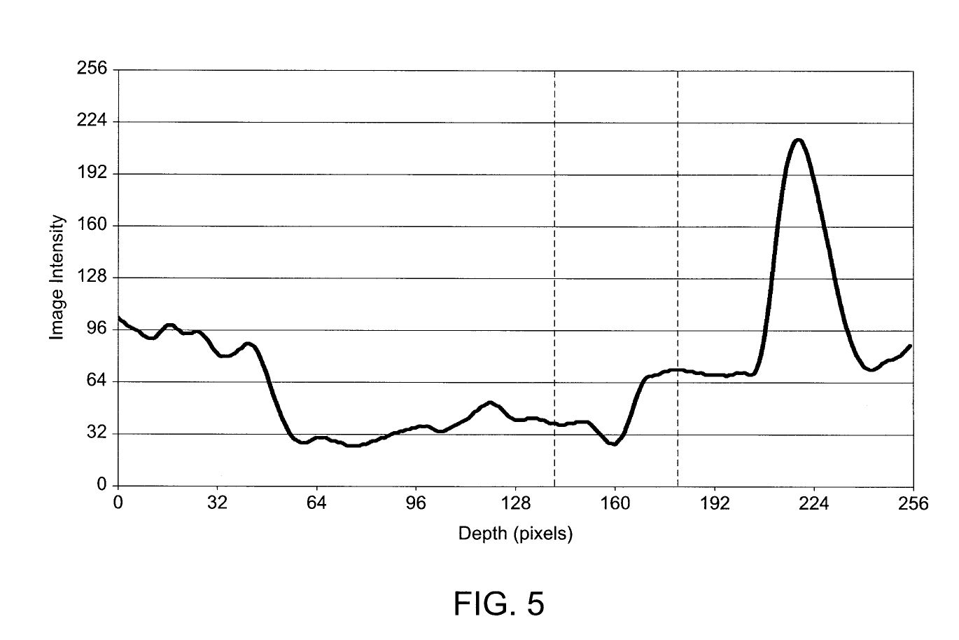

The two dimension chart shown in FIG. 5 is an extraction of the pixel intensities along the vertical line (depth axis) through the operator selected pixel shown in FIG. 3. The reference region shown in FIG. 4 is identified in FIG. 5 as the shaded section around pixel value 160.

The wall detection process selects a time point to the right (increasing time values) of the operator selected time pixel. The step size is small and depending on the acquisition pulse repetition frequency (the rate at which image lines are acquired) can be on the order of about 1 to 10 ms. In terms of image pixels, the time point can be shifted anywhere from about 1 to 100 pixels but typically a small step between about 1 and 5 pixels is used (corresponding to approximately 1 ms of elapsed time). In the examples described herein the time point is shifted to the right. Shifting to the left can also be done.

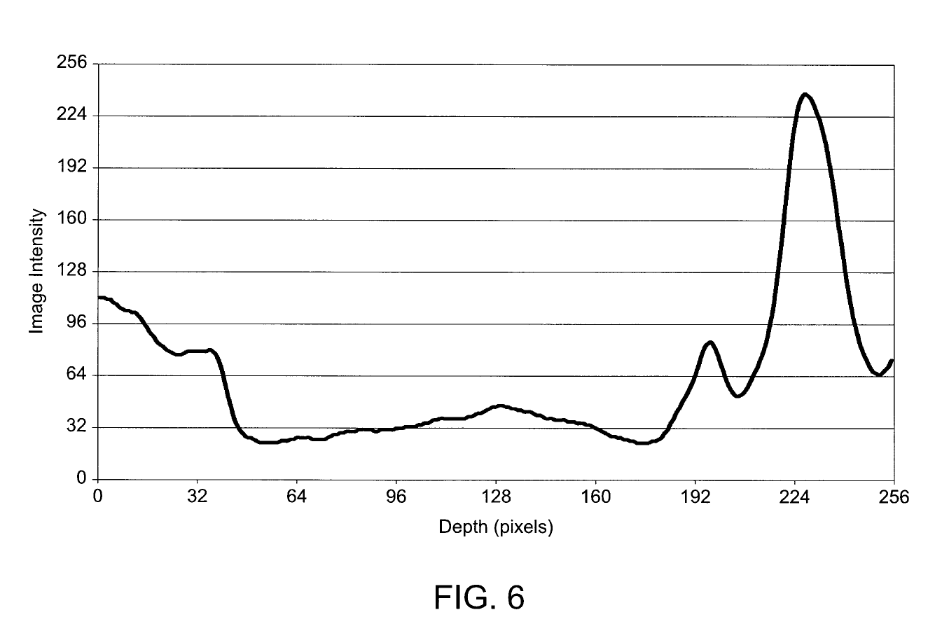

In this example, the time point is shifted 10 pixels to the right. FIG. 6 shows the extraction of the pixel intensities along the reference region, the vertical line through the time point. In FIG. 6 it can be seen that the position of the lower wall has shifted from approximately depth point 160 to about depth point 180.

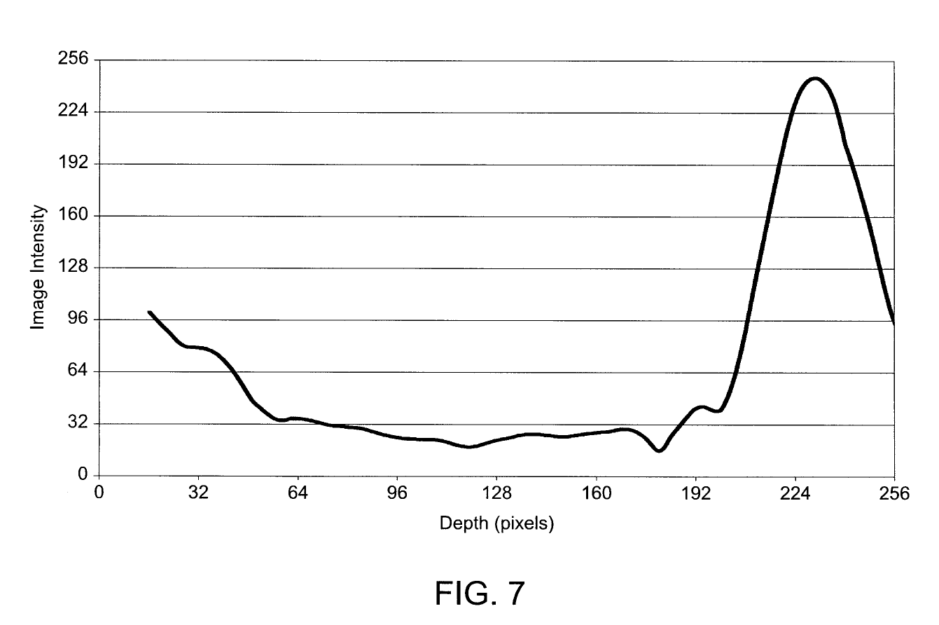

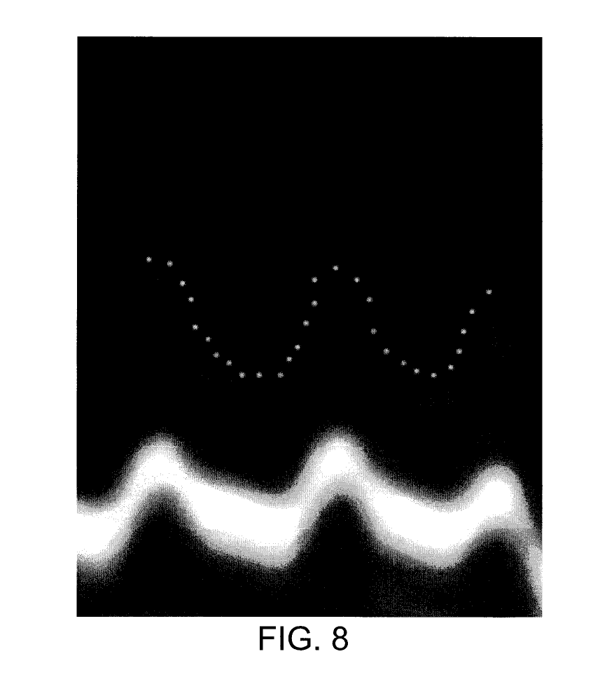

The tracing of the wall is based on comparing the operator selected reference region of FIG. 5 and the comparison region of FIG. 6. This can be done using the minimum of sum of absolute differences whereby the pixel values (image intensity) of the reference data set are subtracted from the pixel values (image intensity) of the comparison data set to give a difference error, using this calculation:

$${Error}_{k} = {\sum }_{i = 0}^{n} {\sum }_{j = 0}^{m} abs ( {Ref}_{i , j} - {Data}_{i , j + k} )$$

$${k}_{min} = min ( {Error}_{k} )$$

Where the two sets most closely match, the difference error will be at a minimum. The result of this operation is shown in FIG. 7. This figure shows a local minimum around depth value 181. This represents the feature pixel at the time point where the reference region most closely matches the comparison region. This is the calculated wall position at that time point. This process is then repeated for other time points until a completed wall trace is available as shown in FIG. 8. How far the trace is extended is an operator selectable option that can be a fixed value based on the heart rate (for example, 3 heart cycles) or selected by the operator as part of the setup phase.

The preceding description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features.

Throughout this application, if various publications are referenced, the disclosures of these publications in their entireties are hereby incorporated by reference into this application in order to more fully describe the state of the art to which this invention pertains.

Unless otherwise expressly stated, it is in no way intended that any method or process set forth herein be construed as requiring that its steps be performed in a specific order. Accordingly, where a method or process claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Accordingly, those who work in the art will recognize that many modifications and adaptations to the present invention are possible and can even be desirable in certain circumstances and are a part of the present invention. Other embodiments of the invention will be apparent to those skilled in the art from consideration of the specification and practice of the invention disclosed herein. Thus, the preceding description is provided as illustrative of the principles of the present invention and not in limitation thereof. It is intended that the specification and examples be considered as exemplary only, with a true scope and spirit of the invention being indicated by the following claims.

What is claimed is:

1. A method for tracing a user selected feature in an M-mode ultrasonic image comprising:
receiving a selected feature of interest of said M-mode ultrasonic image;
generating a reference region substantially about said feature of interest, wherein one or more reference region intensity values are determined for said reference region;
receiving a selected time point in the M-mode ultrasonic image, wherein the time point is at a different time than said feature of interest;
generating a comparison region substantially about said time point, wherein one or more comparison region intensity values are determined for said comparison region;
determining a difference error by performing a comparison between the reference region intensity values and the comparison region intensity values; and
determining a minimum value for said difference error, wherein a location is determined for said minimum difference error and the location of the minimum difference error is identified as a calculated location of the feature of interest at the time point.

2. The method of claim 1 further comprising indicating the calculated location of the feature of interest on said M-mode ultrasonic image.

3. The method of claim 2, wherein indicating the calculated location of the feature of interest on said M-mode ultrasonic image comprises imposing or overlaying a point of differing contrast or color on said M-mode ultrasonic image.

4. The method of claim 2, wherein indicating the calculated location of the feature of interest on said M-mode ultrasonic image comprises displaying the calculated feature of interest location on the M-mode image as lines or curves connecting two or more calculated points.

5. The method of claim 1, wherein receiving a selected feature of interest of said M-mode ultrasonic image comprises receiving a selection of one pixel at a point on the feature of interest.

6. The method of claim 1, wherein said feature of interest comprises a region of interest and receiving a selected feature of interest of said M-mode ultrasonic image comprises receiving a selected first point and a second point that indicate a width of said region of interest.

7. The method of claim 6, wherein said second point is a predefined end point.

8. The method of claim 6, wherein the width of the region of interest can range from 2 pixels to the full width of the M-mode ultrasonic image

9. The method of claim 1, wherein the feature of interest comprises a heart wall edge or an inner heart wall.

10. The method of claim 1, wherein generating a reference region substantially about said feature of interest comprises selecting an n×m window such that “m” represents a vertical axis of the M-mode ultrasonic image and “n” represents the horizontal axis of the M-mode ultrasonic image.

11. The method of claim 10, wherein “n” and “m” are in distance units.

12. The method of claim 10, wherein “n” and “m” are in pixels.

13. The method of claim 10, wherein the n×m window has a size that depends on the resolution of the M-mode ultrasonic image.

14. The method of claim 1, wherein receiving a selected time point in the M-mode ultrasonic image comprises receiving a selected time point that is before said feature of interest's time point.

15. The method of claim 1, wherein receiving a selected time point in the M-mode ultrasonic image comprises receiving a selected time point that is after said feature of interest's time point.

16. The method of claim 1, wherein receiving a selected time point in the M-mode ultrasonic image comprises a processing unit predetermining said time point.

17. The method of claim 1, wherein determining a difference error by performing a comparison between the reference region intensity values and the comparison region intensity values comprises the reference region having an n×m dimension and the comparison region being a line or surface or volume of dimension m comprising m×(entire resolution of the M-mode ultrasonic image).

18. The method of claim 17, wherein the reference region is moved along the comparison region with a difference error being calculated for each point of comparison.

19. The method of claim 1, wherein the difference error is calculated by using the absolute sum of differences shown mathematically as:
$${Error}_{k} = {\sum }_{i = 0}^{n} {\sum }_{j = 0}^{m} abs ( {Ref}_{i , j} - {Data}_{i , j + k} ) ,$$
where k is the currently selected time point and where kₘᵢₙ=min(Errorₖ).

20. The method of claim 1, wherein the difference error is calculated by using the absolute sum of the square of differences shown mathematically as:
$${Error}_{k} = {\sum }_{i = 0}^{n} {\sum }_{j = 0}^{m} {( {Ref}_{i , j} - {Data}_{i , j + k} )}^{2} ,$$
where k is the currently selected time point and where kₘᵢₙ=min(Errorₖ).

21. The method of claim 1, wherein the difference error is calculated by using a convolution equation.

22. The method of claim 1 further comprises applying a filter to remove noise from the M-mode ultrasonic image.

23. The method of claim 22, wherein said filter can be one or more of a Gaussian filter, a box filter, a low-pass filter and a spectral filter.

24. The method of claim 22, wherein said filter is implemented in a frequency domain of said M-mode ultrasonic image.

25. The method of claim 22, wherein said filter is implemented in an image domain of said M-mode ultrasonic image.

26. The method of claim 22 further comprising receiving one or both of a respiration signal and an ECG signal from a subject under consideration for said M-mode ultrasonic image, wherein the respiration signal is configured to provide a waveform indicative of the subject's breathing cycle and the ECG signal is configured to provide a waveform indicative of the subject's heart cycle.

27. The method of claim 26, wherein said ECG signal is used to estimate at what point in the heart cycle a particular M-mode line (time point) occurs such that a previous heart cycle trace is used as a starting point for a heart wall tracing.

28. The method of claim 26, wherein said respiration signal is used to exclude data not representing heart wall motion from said method for tracing a user selected feature in an M-mode ultrasonic image.

29. An apparatus for creating a tracing of a selected feature on an M-mode ultrasonic image comprising:
a processing unit having a data storage device for storing an M-mode ultrasound image; and
a program module having executable code at least a portion of which is stored in the data storage device, said program module provides instructions to the processing unit;
wherein the program module is configured to cause the processing unit to select a pixel of the selected feature within the M-mode image,
generate a reference region about the selected feature pixel,
extract image intensity values for the reference region,
select a time point in the M-mode ultrasonic image, wherein the time point is at a different time than the selected feature pixel,
generate a comparison region about the selected time point,
extract image intensity values for the comparison region,
calculate a difference error for each location within the comparison region by comparing the reference region image intensity values with the comparison regions image intensity values, and
identify the location that has the smallest difference error as a feature pixel at the time point.

30. The apparatus of claim 29, wherein the difference error is calculated by said processing unit using a sum of absolute differences.

31. The apparatus of claim 29, wherein the difference error is calculated by said processing unit by convolution.

32. The apparatus of claim 29, wherein the reference region created by the program module comprises a window.

33. The apparatus of claim 32, wherein the window is about 3 pixels wide and about 32 pixels deep.

34. The apparatus of claim 29, wherein the time point selected in the M-mode ultrasonic image is about 5 pixels from the selected feature pixel.

35. The apparatus of claim 29 further comprising an ultrasound transducer.

36. The apparatus of claim 35, wherein said ultrasound transducer is a high-frequency single-element transducer, a clinical-frequency single-element transducer, or an arrayed transducer.

37. The apparatus of claim 35, wherein said ultrasound transducer transmits ultrasound at a frequency of at least about 20 megahertz (MHz).

38. An M-mode ultrasonic image with a traced selected feature produced by a process comprising:
selecting a pixel of the selected feature within an M-mode ultrasonic image;
generating a reference region about the selected feature pixel;
extracting image intensity values for the reference region;
selecting a time point in the M-mode ultrasonic image, wherein the time point is at a different time than the selected feature pixel;
generating a comparison region substantially about the selected time point, wherein image intensity values are extracted for the comparison region;
calculating a difference error for each location within the comparison region by comparing the reference region image intensity values with the comparison regions image intensity values; and
identifying the location that has the smallest difference error as a feature pixel at the time point to provide the M-mode image with the traced feature.

39. The M-mode ultrasonic image with a traced selected feature of claim 38, wherein the difference error is calculated using a sum of absolute differences.

40. The M-mode ultrasonic image with a traced selected feature of claim 38, wherein the difference error is calculated by convolution.

41. The M-mode ultrasonic image with a traced selected feature of claim 38, wherein the reference region about the selected feature pixel comprises a window.

42. The M-mode ultrasonic image with a traced selected feature of claim 41, wherein the window is about 3 pixels wide and about 32 pixels deep.

43. The M-mode ultrasonic image with a traced selected feature of claim 38, wherein the time point selected in the M-mode ultrasonic image is about 5 pixels from the selected feature pixel.

44. The M-mode ultrasonic image with a traced selected feature of claim 38 further comprising an ultrasound transducer.

45. The M-mode ultrasonic image with a traced selected feature of claim 44, wherein said ultrasound transducer is a high-frequency single-element transducer, a clinical-frequency single-element transducer, or an arrayed transducer.

46. The M-mode ultrasonic image with a traced selected feature of claim 35, wherein said ultrasound transducer transmits ultrasound at a frequency of at least about 20 megahertz (MHz).

47. A computer program product for creating a tracing of a selected feature on an M-mode ultrasonic image, wherein the computer program product comprises at least one computer-readable storage medium having computer-readable program code portions stored therein, the computer-readable program code portions comprising:
a first executable portion for receiving a selected pixel of a selected feature within an M-mode image;
a second executable portion for generating a reference region about the selected feature pixel and extracting image intensity values for the reference region;
a third executable portion for selecting a time point in the M-mode ultrasonic image, wherein the time point is at a different time than the selected feature pixel, generating a comparison region about the selected time point, and extracting image intensity values for the comparison region;
a fourth executable portion for calculating a difference error for each location within the comparison region by comparing the reference region image intensity values with the comparison regions image intensity values, and identifying the location that has the smallest difference error as a feature pixel at the time point.

48. The computer program product of claim 47, wherein the difference error is calculated by said fourth executable portion using a sum of absolute differences.

49. The computer program product of claim 47, wherein the difference error is calculated by said fourth executable portion using convolution.

50. The computer program product of claim 49, wherein the reference region created by the second executable portion comprises a window.

51. The computer program product of claim 50, wherein the window is about 3 pixels wide and about 32 pixels deep.

52. The computer program product of claim 49, wherein the time point selected in the M-mode ultrasonic image is about 5 pixels from the selected feature pixel.
